(19) United States
(12) Patent Application Publication
(10) Pub. No.: US 2017/0248865 A1
(43) Pub. Date: Aug. 31, 2017

(54) IMAGE FORMING APPARATUS

(71) Applicant: FUJI XEROX CO., LTD., Tokyo (JP)

(72) Inventor: Kazuma TERANISHI, Kanagawa (JP)

(73) Assignee: FUJI XEROX CO., LTD., Tokyo (JP)

(21) Appl. No.: 15/222,194

(22) Filed: Jul. 28, 2016

(30) Foreign Application Priority Data
Feb. 25, 2016 (JP) 2016-034617

(51) Int. Cl. G03G 15/02

(52) U.S. Cl. CPC G03G 15/0266

(57) ABSTRACT

An image forming apparatus includes an image forming unit that forms an image by forming an electrostatic latent image on an image carrier, which is charged by a charging member to which a normal voltage is applied, on the basis of image information and by supplying a developer to the image carrier; an application unit that applies a special alternating-current voltage to the charging member, the special alternating-current voltage at least having an amplitude that is greater than that of an alternating-current voltage that is applied when forming the image; and an instruction unit that instructs the application unit to apply the special alternating-current voltage at a specific time in a period other than an image forming period during which the image forming unit forms the image.

### CROSS-REFERENCE TO RELATED APPLICATIONS

This application is based on and claims priority under 35 USC 119 from Japanese Patent Application No. 2016-034617 filed Feb. 25, 2016.

### BACKGROUND

(i) Technical Field

The present invention relates to an image forming apparatus.

(ii) Related Art

Some image forming apparatuses uniformly charge a surface of a photoconductor, which is an image carrier, by causing a charging member (charging roller) to contact the surface and applying a normal voltage to the charging member; form an electrostatic latent image on the photoconductor on the basis of image information; develop the electrostatic latent image by supplying a developer (such as a toner); and transfer the developed image to an object. Regarding such image forming apparatuses, it is known that a smear on the charging member may reduce the charging performance of the charging member and may affect the quality of the image.

### SUMMARY

According to an aspect of the invention, an image forming apparatus includes an image forming unit that forms an image by forming an electrostatic latent image on an image carrier, which is charged by a charging member to which a normal voltage is applied, on the basis of image information and by supplying a developer to the image carrier; an application unit that applies a special alternating-current voltage to the charging member, the special alternating-current voltage at least having an amplitude that is greater than that of an alternating-current voltage that is applied when forming the image; and an instruction unit that instructs the application unit to apply the special alternating-current voltage at a specific time in a period other than an image forming period during which the image forming unit forms the image.

### BRIEF DESCRIPTION OF THE DRAWINGS

An exemplary embodiment of the present invention will be described in detail based on the following figures, wherein:

FIG. 1 is a front view of an image forming apparatus according to the present exemplary embodiment;

FIG. 2 is a control block diagram of an image-formation-processing engine of the image forming apparatus according to the present exemplary embodiment;

FIG. 3A illustrates current-amplitude characteristic diagram of alternating-current voltages used for image-formation processing, and FIG. 3B illustrates current-amplitude characteristic diagram of alternating-current voltages used for smear-removal processing;

FIG. 4 is a functional block diagram, according to the present exemplary embodiment, of an image-formation processing controller and a charging controller for generating a voltage applied to a charging roller;

FIG. 5 is a control flowchart of an image-forming-unit replacement determination routine according to the present exemplary embodiment;

FIG. 6 is a control flowchart of a processing-amount accumulation routine according to the present exemplary embodiment;

FIG. 7 is a flowchart of a smear-removal-processing control routine performed in step 278 of FIG. 6;

FIG. 8 is a timing chart, according to the present exemplary embodiment, illustrating how the voltages applied to image forming units are controlled when performing smear-removal processing; and

FIG. 9 is a characteristic diagram, according to the present exemplary embodiment, showing the sensory evaluation values of smear-removal effect for different voltages in a case where it is possible to increase the amplitude by reducing the frequency.

### DETAILED DESCRIPTION

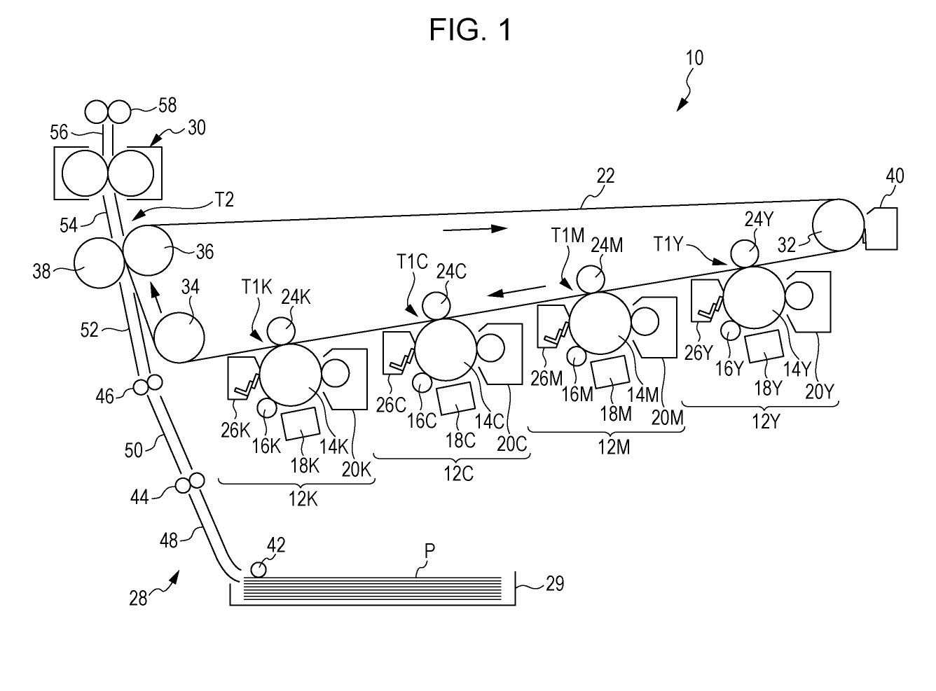

FIG. 1 is a schematic view of an image forming apparatus 10 according to an exemplary embodiment.

The image forming apparatus 10 is a four-unit tandem image forming apparatus that is capable of forming a full-color image (also referred to as “printing”). The image forming apparatus 10 includes a first image forming unit 12Y, a second image forming unit 12M, a third image forming unit 12C, and a fourth image forming unit 12K, each of which is an example of an image forming unit and which respectively form a yellow (Y) image, a magenta (M) image, a cyan (C) image, and a black (K) image by using an electrophotographic method. The image forming units 12Y, 12M, 12C, and 12K are arranged in this order from the upstream side so as to be spaced apart from each other by a predetermined distance.

In the following description, each of the first image forming unit 12Y, the second image forming unit 12M, the third image forming unit 12C, and the fourth image forming unit 12K will be referred to as the “image forming unit 12”, because the four image forming units have the same structure. When it is not necessary to distinguish between corresponding components of the image forming units 12, the characters “Y”, “M”, “C”, and “K” at the ends of the numerals of the components, which are shown in the figures, may be omitted in the description.

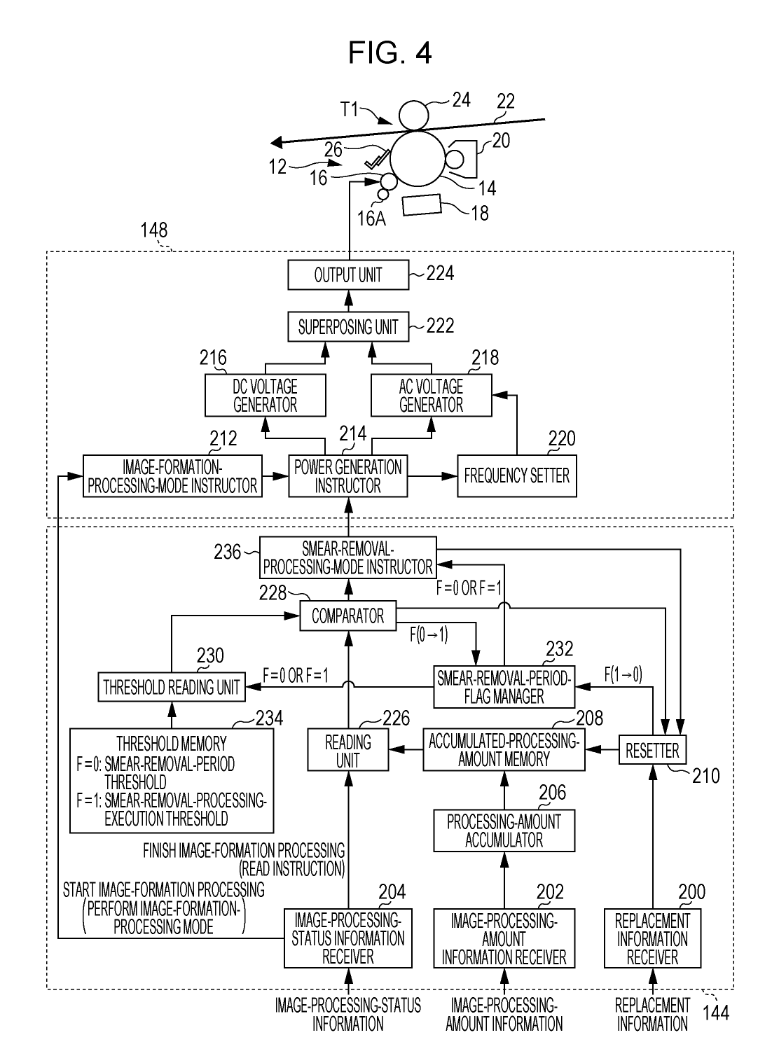

The image forming unit 12 includes a photoconductor drum 14, a charging roller 16, an exposure unit 18, a developing unit 20, and a cleaning unit 26. The photoconductor drum 14 has a photoconductor layer on a surface thereof. The charging roller 16 uniformly charges the photoconductor drum 14. The exposure unit 18 irradiates the photoconductor drum 14, which has been uniformly charged, with light to form an electrostatic latent image. The developing unit 20 forms a toner image by transferring toner to the latent image. The cleaning unit 26 removes toner remaining on the photoconductor drum 14 after transfer. A charging-roller-cleaning roller 16A (see FIG. 4) is disposed adjacent to the charging roller 16.

The image forming apparatus 10 further includes an intermediate transfer belt 22 and first-transfer rollers 24. The intermediate transfer belt 22, which is an example of an image carrier, is an endless belt that is rotatably looped along a path that is in contact with the photoconductor drums 14 of the four image forming units 12. Each of the first-transfer rollers 24 transfers a toner image, formed on a corresponding one of the photoconductor drums 14, to the intermediate transfer belt 22. The photoconductor drums 14 and the first-transfer rollers 24 face each other in first-transfer sections T1.

The image forming apparatus 10 further includes a recording sheet transport mechanism 28 and a fixing unit 30. The recording sheet transport mechanism 28 transports a recording sheet P from a sheet tray 29. The fixing unit 30 fixes a toner image onto the recording sheet P.

The intermediate transfer belt 22 is looped over a drive roller 32 that rotates the intermediate transfer belt 22; a tension roller 34 that adjusts the tension of the intermediate transfer belt 22; and a backup roller 36, which is an example of an opposing member. The first-transfer rollers 24 are disposed inside the loop of the intermediate transfer belt 22.

A second-transfer roller 38, which is an example of a transfer member, is disposed opposite the backup roller 36 with the intermediate transfer belt 22 therebetween. The second-transfer roller 38 transfers a toner image on the intermediate transfer belt 22 to a recording sheet P that is being transported by the recording sheet transport mechanism 28. The backup roller 36 and the second-transfer roller 38 face each other in a second-transfer section T2.

A toner removing unit 40 is disposed opposite the drive roller 32 with the intermediate transfer belt 22 therebetween. The toner removing unit 40 removes toner from the intermediate transfer belt 22 after the second-transfer roller 38 has transferred toner images from the intermediate transfer belt 22 to the recording sheet P.

The recording sheet transport mechanism 28 includes a pick-up roller 42; transport rollers 44 and 46; paper guides 48, 50, 52, 54, and 56 that form a recording-sheet transport path; sheet-output rollers 58; and a sheet output tray (not shown). The recording sheet transport mechanism 28 transports a recording sheet P from the sheet tray 29 to a second-transfer position, where the second-transfer roller 38 and the backup roller 36 are disposed opposite each other with the intermediate transfer belt 22 therebetween. Then, the recording sheet transport mechanism 28 transports the recording sheet P from the second-transfer position to the fixing unit 30, and from the fixing unit 30 to the sheet output tray.

### Engine Control System

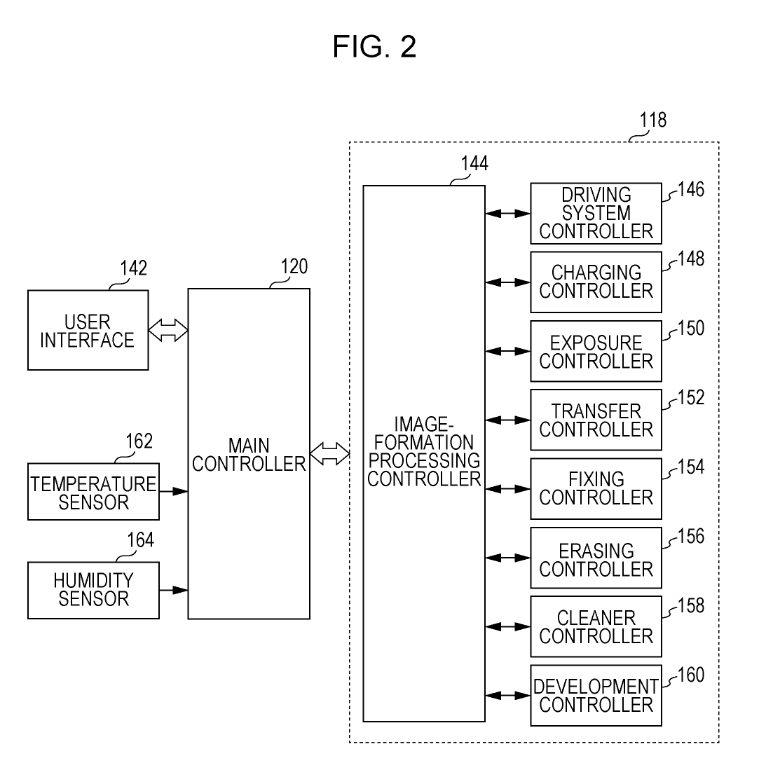

FIG. 2 is a control block diagram illustrating an example of the control system of the image forming apparatus 10.

A user interface 142 is connected to a main controller 120 of the image forming apparatus 10. The user interface 142 includes an input unit, to which a user inputs an instruction that is related to an image forming operation or the like, and an output unit, which notifies information about an image forming operation or the like by using a display or a sound.

Image data is input to the main controller 120 through a network line that is connected to an external host computer (not shown).

When image data is input, the main controller 120 analyses, for example, the image data and print instruction information included in the image data, converts the data format of the image data into a data format (for example, bitmap) that is compatible with the image forming apparatus 10, and feeds the converted image data to an image-formation processing controller 144, which functions as a part of an MCU 118.

On the basis of input image data, the image-formation processing controller 144 performs an image forming operation by synchronously controlling a driving system controller 146, a charging controller 148, an exposure controller 150, a transfer controller 152, a fixing controller 154, an erasing controller 156, a cleaner controller 158, and a development controller 160. Each of these controllers functions as a part of the MCU 118, as with the image-formation processing controller 144. In the present exemplary embodiment, the functions performed by the MCU 118 are divided into blocks. However, these blocks do not limit the hardware structure of the MCU 118.

A temperature sensor 162, a humidity sensor 164, and the like may be connected to the main controller 120. In this case, the temperature sensor 162 and the humidity sensor 164 detect the ambient temperature and the humidity of the inside of the housing of the image forming apparatus 10.

### Life of Image Forming Unit 12

When the image forming unit 12 has performed a predetermined amount of image-formation processing (has performed image-formation processing on a predetermined number of pages), it is necessary to determine that the life of the image forming unit 12 has expired and to replace the image forming unit 12. The life of the charging roller 16 expires due to, for example, a smear on the surface of the charging roller 16.

Because the charging roller 16 is in contact with the photoconductor drum 14, after image-formation processing has been finished, a toner that remains on the photoconductor drum 14, which was not transferred to the recording sheet P and was not removed by the cleaning unit 26, may adhere to the photoconductor drum 14.

Because the charging roller 16 is disposed adjacent to the charging-roller-cleaning roller 16A, a smear due to temporary adhesion of toner can be removed. However, as toner remains and accumulates on the charging roller 16 over time, the toner solidifies into a film-like shape due to frictional heat generated between the charging roller 16 and the photoconductor drum 14. This is called a filming phenomenon.

When the filming phenomenon occurs on a region of the charging roller 16, a portion of the photoconductor drum 14 corresponding to the region may not be charged properly. As a result, an image defect, which has a striped pattern extending in the transport direction (sub-scanning direction) of the recording sheet P, may occur.

Basically, occurrence of a filming phenomenon can be predicted from the life of the image forming unit 12. However, depending on an environment in which the image forming apparatus 10 is used, the filming phenomenon may occur before the life of the image forming unit expires.

To be more specific, in a case where the life of the image forming unit 12 corresponds to 150000 pages (when converted to the number of pages of A4-sized recording sheets P), the filming phenomenon may occur when only 100000 pages have been processed.

The applicant of the present application found the following: when the filming phenomenon of the charging roller 16 occurs, by applying, to the charging roller 16, an alternating-current voltage having an amplitude Vpp greater than that of a voltage applied to the charging roller 16 for image-formation processing, a film formed on the surface of the charging roller 16 due to the filming phenomenon is broken (cut) in the thickness direction of the film and the charging performance of the charging roller 16 is restored.

In the present exemplary embodiment, the charging controller 148 of the MCU 118 has the following modes: an image-formation-processing mode for charging the photoconductor drum 14 when performing ordinary image-formation processing; and a smear-removal-processing mode for removing a smear on the charging roller 16, which is generated due to the filming phenomenon.

On the charging roller 16, an application voltage is generated by superposing an alternating-current voltage having a specific frequency on a direct-current voltage. By superposing the alternating-current voltage, the photoconductor drum 14 can be charged stably and with a lower voltage than by using only a direct-current voltage.

### Alternate-Current Voltage in Image-Formation-Processing Mode

In the image-formation-processing mode, it is necessary that an alternating-current voltage applied to the charging roller 16 have a frequency (hereinafter, referred to a charging-roller frequency f) that does not interfere with a scanning line when the exposure unit 18 forms an electrostatic latent image in accordance with image information and that does not cause an image defect (in particular, moiré). The term “moiré” refers to a pattern of light and dark stripes formed in an image. Occurrence of moiré depends on the frequency of the alternating-current voltage, and a moiré-occurrence-peak frequency exists depending on the process speed.

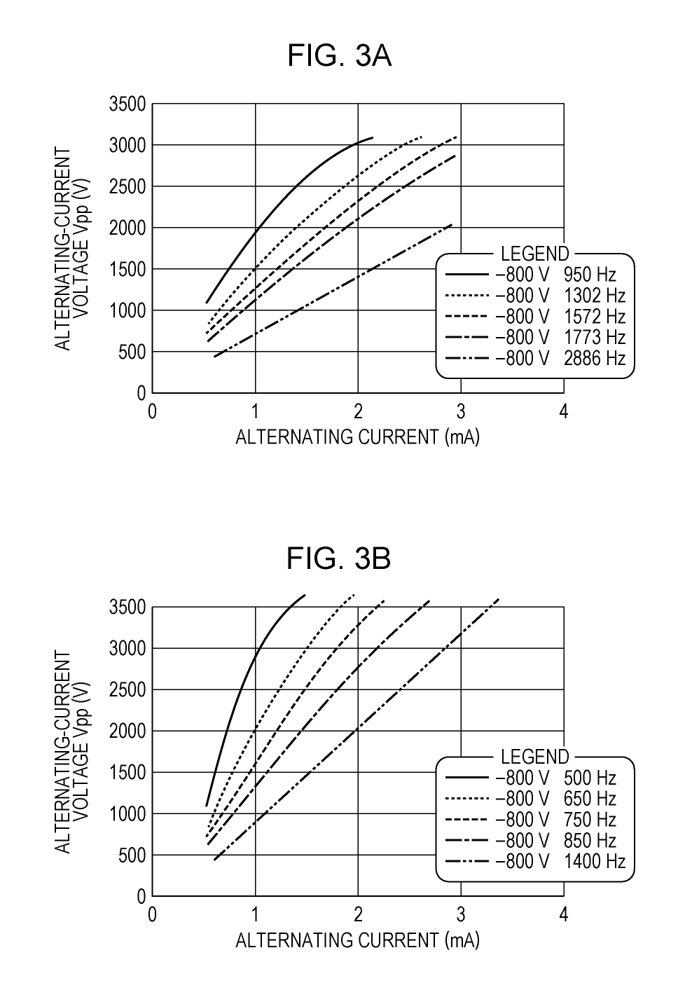

FIG. 3A is a characteristic diagram illustrating alternating-current voltages (see the legend of the graph) that can be used in the image-formation-processing mode.

For example, the application voltage that can be practically used in the image-formation-processing mode is generated by superposing an alternating-current voltage AC having an amplitude Vpp in the range of 1000 to 2500 V on a direct-current voltage in the range of −600 to −800 V. The sign of the application voltage depends on the polarity of the charge of a developer (toner particles) used.

Therefore, from the alternating-current voltages shown in (the legend of) FIG. 3A, an alternating-current voltage is selected and used from the point of view of preventing occurrence of moiré, which may occur depending on the process speed, and troubles such as vibration.

It can be seen from FIG. 3A that the amplitude Vpp can be effectively increased by reducing the frequency.

### Alternating-Current Voltage in Smear-Removal-Processing Mode

As described above, in the smear-removal-processing mode, an alternating-current voltage having an amplitude Vpp that is greater than that of an alternating-current voltage for performing image-formation processing is applied to the charging roller 16.

In this case, in contrast to image-formation processing, it is not necessary to take the image quality, such as moiré, into consideration.

As illustrated in FIG. 3B, for the same alternating-current voltage (−800 V), the maximum amplitude Vpp can be increased by reducing the frequency.

Accordingly, in the smear-removal-processing mode according to the present exemplary embodiment, the alternating-current voltages shown in FIG. 3A, which are used in the image-formation-processing mode, are used by reducing the frequency.

FIG. 4 is a functional block diagram of the image-formation processing controller 144 and the charging controller 148 (see FIG. 2) for generating a voltage that is applied to the charging roller 16. The blocks shown in FIG. 4 are functional blocks and do not limit the hardware structures of the image-formation processing controller 144 and the charging controller 148.

The image-formation processing controller 144 includes a replacement information receiver 200, an image-processing-amount information receiver 202, and an image-processing-status information receiver 204.

The replacement information receiver 200 receives information indicating that the image forming unit 12 is replaced.

The image-processing-amount information receiver 202 receives, for example, information on the number of pages (“print volume” or “pv”), converted to the number of pages of A4-size sheets, that are processed.

The image-processing-status information receiver 204 receives information on the status of image-formation processing, including a time at which image-formation processing is started or a time at which the image-formation processing is finished.

In the image-formation processing controller 144, in order to determine whether or not to perform smear-removal processing on the charging roller 16, a processing-amount accumulator 206 accumulates the amount of image-formation processing, which is received by the image-processing-amount information receiver 202; and an accumulated-processing-amount memory 208 successively stores the accumulated image processing amount.

The accumulated processing amount is zero at a time at which the image forming unit 12 is replaced. Therefore, when the replacement information receiver 200 receives information indicating that the image forming unit 12 is replaced, a resetter 210 resets the accumulated processing amount, which is stored in the accumulated-processing-amount memory 208, to 0 pages.

When the image-processing-status information receiver 204 receives image-formation-processing-start information, the image-processing-status information receiver 204 sends the image-formation-processing-start information to an image-formation-processing-mode instructor 212 of the charging controller 148.

The image-formation-processing-mode instructor 212 is connected to a power generation instructor 214, which is an example of an application unit. The power generation instructor 214 is connected to a DC voltage generator 216; an AC voltage generator 218, which is an example of an application unit; and a frequency setter 220, which is an example of an application unit. The frequency setter 220 is connected to the AC voltage generator 218 and sets the frequency of an AC voltage that is generated. The DC voltage generator 216 and the AC voltage generator 218 are connected to a superposing unit 222. The superposing unit 222 generates an application voltage to be applied to the charging roller 16 by superposing an alternating-current voltage having a preset frequency and a preset amplitude on a preset direct current voltage.

For example, from the voltages shown in the legend of FIG. 3A, a charging voltage is selectively generated by superposing an alternating-current voltage having an amplitude Vpp of 2000 V and a frequency of 950 Hz, at which moiré does not occur, on a direct-current voltage of −800 V.

The generated charging voltage is output through an output unit 224 at a charging time. Thus, the charging roller 16 is charged.

When the image-processing-status information receiver 204 of the image-formation processing controller 144 receives information indicating that image-formation processing has been finished, the image-processing-status information receiver 204 instructs a reading unit 226 to read the accumulated processing amount from the accumulated-processing-amount memory 208.

The reading unit 226 is connected to a comparator 228 and sends the accumulated processing amount to the comparator 228.

The comparator 228 reads a threshold from a threshold reading unit 230 in order to compare the accumulated processing amount with the threshold.

The threshold reading unit 230 reads different thresholds in accordance with the value (0 or 1) of a flag F that is managed by a smear-removal-period-flag manager 232.

That is, the resetter 210 and the comparator 228 are connected to the smear-removal-period-flag manager 232.

When the image forming unit 12 is replaced, the resetter 210 outputs a signal that causes the smear-removal-period-flag manager 232 to reset the flag F (F=0).

When the image-formation-processing amount (that is, the amount of image-formation processing that has been performed by the image forming unit 12) reaches a predetermined amount (for example, 150000 pages) that corresponds to a smear-removal period, the comparator 228 outputs a signal that causes the smear-removal-period-flag manager 232 to set the flag F (F=1).

When the flag F is 0, the threshold reading unit 230 reads, from a threshold memory 234, a threshold that is used to determine whether or not the image-formation-processing amount has reached an amount at which smear-removal-processing should be performed.

When the flag F is 1, the threshold reading unit 230 reads, from the threshold memory 234, a threshold that is used to determine whether or not to the present time is the time to perform the smear-removal processing.

The comparator 228 is connected to a smear-removal-processing-mode instructor 236, which is an example of an instruction unit. The smear-removal-processing-mode instructor 236 can recognize the flag F in the smear-removal-period-flag manager 232 and effectively functions when the flag F is set (F=1). By receiving an execution instruction from the comparator 228, the smear-removal-processing-mode instructor 236 instructs the power generation instructor 214 of the charging controller 148 to generate electric power for performing the smear-removal processing.

Exemplary operations performed by the smear-removal-processing-mode instructor 236 are as follows.

Exemplary Operation 1: When the flag F is 0, that is, until the image-formation-processing amount exceeds 100000 pages, the smear-removal-processing mode is not performed.

Exemplary Operation 2: When the flag F is 1, that is, after the image-formation-processing amount has exceeded 100000 pages, the smear-removal-processing mode is performed every time the image-formation-processing amount increases by 10000 pages.

For example, electric power (−800 V, 950 Hz) used for image-formation processing is selected from the legend of FIG. 3A. Because it is not necessary take image quality, such as moiré, into consideration, a charging voltage is generated by superposing an alternating current, whose amplitude Vpp is increased to 3500 V by reducing the frequency to 500 Hz as illustrated in FIG. 3B, on a direct current voltage.

This charging voltage for the smear-removal-processing mode (DC −800 V, frequency 500 Hz, Vpp 3500 V), which is not suitable for image-formation processing, is effective in breaking (cutting) a film generated on the surface of the charging roller 16 in the thickness direction of the film and in restoring the charging function of the charging roller 16.

Hereinafter, an operation of the present exemplary embodiment will be described.

### Ordinary Image-Formation-Processing Mode

Because the image forming units 12 have substantially the same structure, the first image forming unit 12Y, which is disposed in an upstream region in the rotation direction of the intermediate transfer belt 22 and which forms an yellow image, will be described as a representative example. By respectively denoting components of the second to fourth image forming units 12M, 12C, and 12K by numerals to which magenta (M), cyan (C), and black (K) are attached instead of yellow (Y), description of the second to fourth image forming units 12M, 12C, and 12K will be omitted.

First, before starting the operation, the photoconductor drum 14Y starts rotating, and the charging roller 16Y charges the surface of the photoconductor drum 14Y to a predetermined potential by applying a voltage generated by superposing an alternating current on a direct current in the present exemplary embodiment. Generally, the charging potential is selectable in the range of −400 V to −800 V. For example, when charging the photoconductor drum 14Y, a voltage generated by superposing an alternating-current voltage, having a specific amplitude Vpp and a specific frequency f, on a direct-current voltage is applied to the charging roller 16Y.

The photoconductor drum 14Y includes an electroconductive metal body and a photoconductive layer formed on the metal body. The photoconductor drum 14Y normally has a high resistance. However, when a part of the photoconductor drum 14Y is irradiated with LED light, the resistance of the portion changes.

When image data for yellow is sent from the main controller 120 to the MCU 118, the exposure unit 18 emits an exposure light beam (such as an LED light beam) toward the surface of the photoconductor drum 14Y in accordance with the image data. The surface of the photoconductive layer of the photoconductor drum 14Y is irradiated with the light beam, and thereby an electrostatic latent image of a yellow printing pattern is formed on the surface of the photoconductor drum 14Y.

The electrostatic latent image is a so-called negative latent image formed on the surface of the photoconductor drum 14Y due to charging. The electrostatic latent image is formed because the resistivity of a part of the photoconductive layer irradiated with the light beam is reduced and charges on the surface of the photoconductor drum 14Y flow away while charges on a part of the photoconductor layer that is not irradiated with the light beam remain.

The electrostatic latent image, which is formed on the photoconductor drum 14Y as described above, is rotated to a development position as the photoconductor drum 14Y rotates. At the development position, the developing unit 20Y develops the electrostatic latent image on the photoconductor drum 14Y into a visible image (toner image).

The developing unit 20Y contains yellow toner, which is manufactured by using an emulsion polymerization method. The yellow toner, which is agitated in the developing unit 20Y, is charged by friction to have the same (negative) polarity as the surface of the photoconductor drum 14Y.

As the surface of the photoconductor drum 14Y passes through the developing unit 20Y, the yellow toner electrostatically adheres to only a part of a latent image on the photoconductor drum 14Y from which charges have been erased, and the latent image is developed by using the yellow toner.

As the photoconductor drum 14Y continues rotating, the toner image developed on the surface of the photoconductor drum 14Y is transported to a first-transfer position. When the yellow toner image on the surface of the photoconductor drum 14Y is transported to the first-transfer position, a first-transfer bias is applied to the first-transfer roller 24Y. Accordingly, the toner image receives an electrostatic force in the direction from the photoconductor drum 14Y toward the first-transfer roller 24Ye, and the toner image is transferred from the surface of the photoconductor drum 14Y to the surface of the intermediate transfer belt 22.

The transfer bias has the positive polarity, which is opposite to the negative polarity of the toner. For example, in the first image forming unit 12Y, the transfer controller 152 performs constant-current control to keep the transfer bias in the range of about +20 to 30 μA.

The cleaning unit 26Y removes residual toner remaining on the surface of the photoconductor drum 14Y after transfer.

First-transfer biases applied to the first-transfer rollers 24M, 24C, and 24K of the second to fourth image forming units 12M, 12C, and 12K are controlled in the same way as described above.

The intermediate transfer belt 22, to which the first image forming unit 12Y has transferred a yellow toner image, passes through the second to fourth image forming units 12M, 12C, and 12K successively, and magenta, cyan, and black toner images are transferred to the intermediate transfer belt 22 in an overlapping manner.

The intermediate transfer belt 22, to which all the color toner images have been transferred from all the image forming units 12 in an overlapping manner, continues to rotate in the direction of an arrow and reaches the second-transfer section T2. In the second-transfer section T2, the backup roller 36 is in contact with the inner surface of the intermediate transfer belt 22, and the second-transfer roller 38 is disposed so as to face the image-carrying surface of the intermediate transfer belt 22.

A feed mechanism feeds a recording sheet P to the nip between the second-transfer roller 38 and the intermediate transfer belt 22 at a predetermined timing, and a second-transfer bias is applied to the second-transfer roller 38.

The second-transfer bias has the positive polarity, which is opposite to the negative polarity of the toner. The toner images receive an electrostatic force from the intermediate transfer belt 22 toward the recording sheet P, and the toner images are transferred from the surface of the intermediate transfer belt 22 to the surface of the recording sheet P.

Subsequently, the recording sheet P is fed into the fixing unit 30, which heats and presses the overlapping color toner images to fuse and permanently fix the toner images to the surface of the recording sheet P. After the color images has been fixed to the recording sheet P, the recording sheet P is transported to the output unit, and the color image forming process is finished.

### Control of Smear-Removal Processing of Charging Roller 16

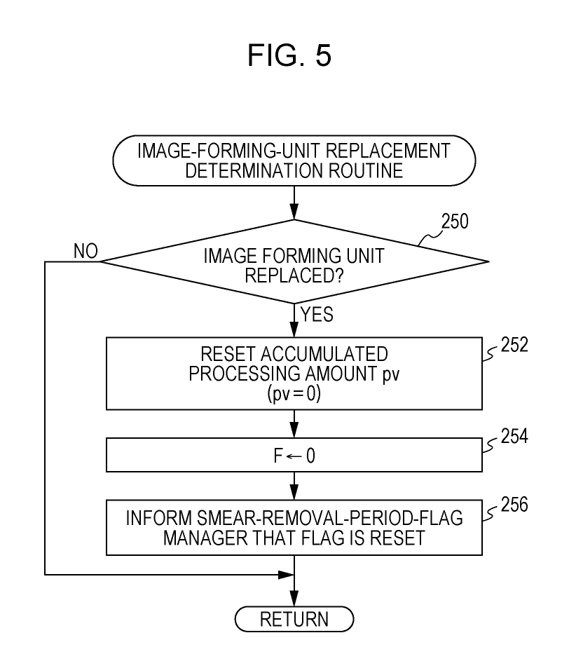

FIGS. 5 to 7 are control flowcharts related to smear-removal-processing control performed by the image-formation processing controller 144 and the charging controller 148.

FIG. 5 is a control flowchart of an image-forming-unit replacement determination routine according to the present exemplary embodiment.

In step 250, whether or not the image forming unit 12 is replaced is determined. If the determination is NO, the routine finishes. If the determination in step 250 is YES, the process proceeds to step 252. In step 252, the accumulated processing amount pv, which is stored in the accumulated-processing-amount memory 208 (see FIG. 4), is reset (pv=0), and the process proceeds to step 254. In step 254, the flag F, which represents whether or not the present time is in a smear-removal period, is reset (F=0), and the process proceeds to step 256. In step 256, the result of resetting the flag F is notified to the smear-removal-period-flag manager 232 (see FIG. 4), and the routine finishes.

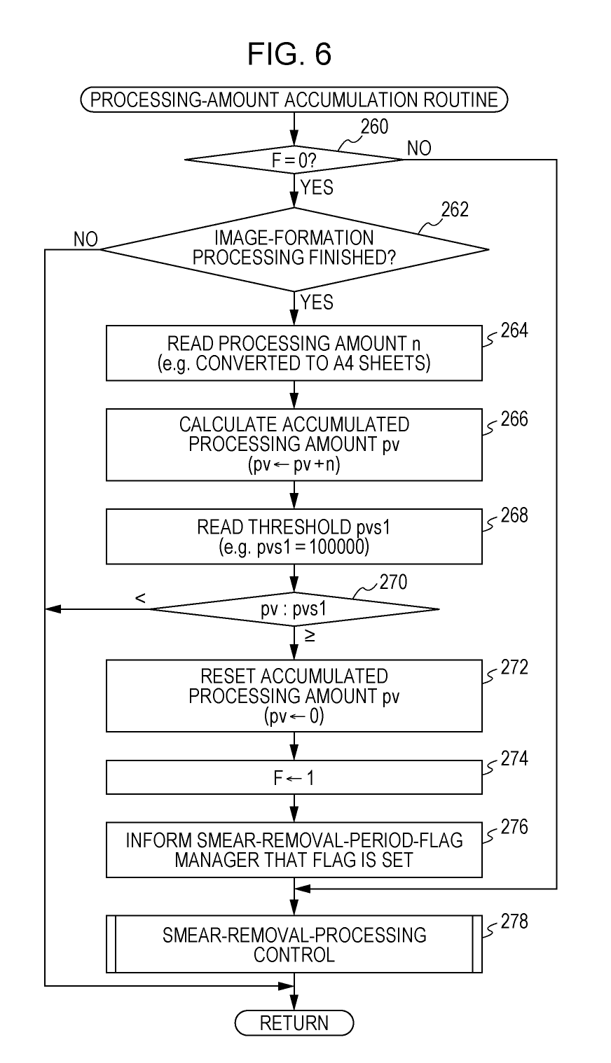

FIG. 6 is a control flowchart of a processing-amount accumulation routine according to the present exemplary embodiment.

In step 260, whether or not the flag F is reset (F=0) is determined. If the determination is YES (F=0), the process proceeds to step 262. In step 262, whether or not image-formation processing has been finished is determined. If the determination in step 260 is NO (F=1), the process proceeds to step 278. The step 278 will be described below.

If the determination in step 262 is NO, it is determined that the present time is not the time to accumulate the processing amount, and the routine finishes.

If the determination in step 262 is YES, it is determined that the present time is the time to accumulate the processing amount, and the process proceeds to step 264. In step 264, a processing amount n (converted to the number of pages of A4-size sheets) of the present image-formation processing is read, and the process proceeds to step 266. In step 266, the processing amount n is added to the accumulated processing amount pv (pv←pv+n).

In step 268, a threshold pvs1 is read. In this case, because the flag F is reset (F=0), a smear-removal-period threshold pvs1 is read. In the present exemplary embodiment, the threshold pvs1 is 100000 pages, which is ⅔ of an amount (150000 pages) at which the life of the image forming unit 12 expires. However, the value of the threshold pvs1 is not limited to this value.

In step 270, the accumulated processing amount pv is compared with the threshold pvs1. If pv<pvs1, it is determined that the processing amount has not reached a predetermined amount that corresponds to the smear-removal period, and the routine finishes.

If pv≧pvs1 in step 270, it is determined that the processing amount has reached the predetermined amount that corresponds to the smear-removal period, and the process proceeds to step 272. In step 272, the accumulated processing amount pv is reset.

In step 274, the flag F is set (F=1), and the process proceeds to step 276. In step 276, the result of setting the flag F is notified to the smear-removal-period-flag manager 232 (see FIG. 4), and the process proceeds to step 278. The step 278 is a step to which the process proceeds also if the determination in the aforementioned step 260 is YES (that is, if the flag F has already been set (F=1)).

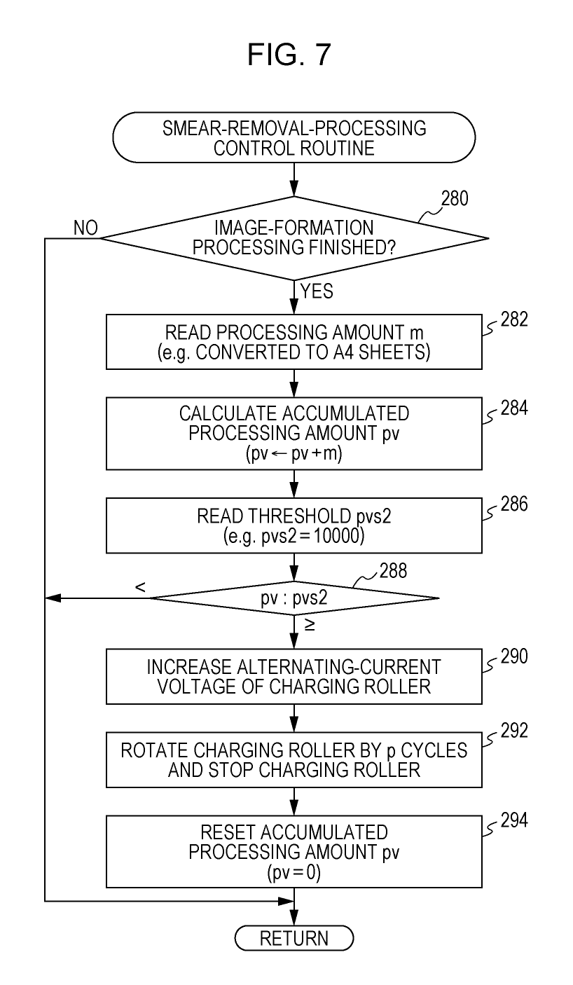

In step 278, smear-removal-processing control is performed (see FIG. 7 for details).

FIG. 7 is a flowchart of a smear-removal-processing control routine performed in step 278 of FIG. 6.

In step 280, whether or not image-formation processing has been finished is determined. If the determination is NO, it is determined that the present time is not the time to perform smear-removal processing, and the routine finishes.

If the determination in step 280 is YES, it is determined that the present time is the time to determine whether or not to perform smear-removal processing, and the process proceeds to step 282. In step 282, a processing amount m (converted to the number of pages of A4-size sheets) is read, and the process proceeds to step 284. In step 284, the processing amount m is added to the accumulated processing amount pv (pv←pv+m).

In step 286, a threshold pvs2 is read. In this case, because the flag F has been set (F=1), a smear-removal-processing-execution threshold pvs2 is read. In the present exemplary embodiment, the threshold pvs2 is 10000 pages. However, the value of the threshold pvs2 is not limited to this value.

In step 288, the accumulated processing amount pv is compared with the threshold pvs2. If pv<pvs2, it is determined that the present time is not the time to perform a smear-removal processing, and the routine finishes.

If pv≧pvs2 in step 288, it is determined that the present time is the time to perform smear-removal processing, and the process proceeds to step 290. In step 290, the alternating-current voltage applied to the charging roller 16 is increased. To be specific, the amplitude Vpp is increased by reducing the frequency to a level (for example, 500 Hz) that is lower than that (for example, 950 Hz) for performing ordinary image-formation processing.

In the present exemplary embodiment, the amplitude Vpp is increased to 3500 V, as compared with an amplitude of 2000 V for performing image-formation processing.

In step 292, the charging roller 16 is rotated by p cycles and then stopped. Due to the rotation, a voltage (Vpp) of 3500 V is applied to the entire periphery of the charging roller 16. Accordingly, a film formed on the charging roller 16 due to the filming phenomenon is broken (cut), and the charging function of the charging roller 16 for performing subsequent image-formation processing is restored. In step 294, the accumulated processing amount pv is reset (pv=0), and the routine finishes.

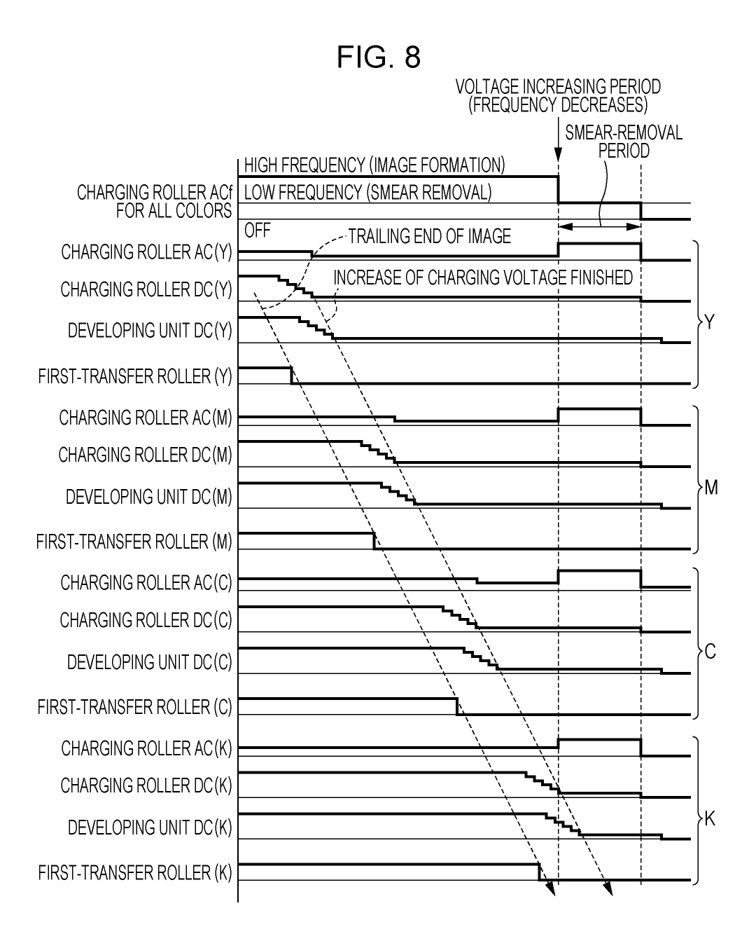

FIG. 8 is a timing chart illustrating how the voltages applied to the image forming unit 12 are controlled when performing smear-removal processing.

The “charging roller ACf” is the frequency of alternating-current voltages applied to the charging rollers 16 for all colors.

The “charging roller AC (color symbol) is the alternating-current voltage of the charging roller 16 for the corresponding color.

The “charging roller DC (color symbol)” is the direct-current voltage of the charging roller 16 for the corresponding color.

The “developing unit DC (color symbol)” is a direct-current voltage applied to the developing unit 20 for the corresponding color.

The “first transfer roller (color symbol)” is a direct-current voltage applied to the first-transfer roller 24 in the first-transfer region T1 for the corresponding color.

In the present exemplary embodiment, smear-removal processing is simultaneously performed on the charging rollers 16 all colors.

Timing at which the trailing end of an image passes and an increase in the charging voltage of the charging roller 16 finishes differs between the colors. In the present exemplary embodiment, after an increase in the charging voltage for K (black) is finished, the frequency of the alternating-current voltage applied to the charging rollers 16, which is common to all colors, is reduced. By doing so, the amplitude Vpp of the alternating-current voltage applied to the charging rollers 16 for all colors increases, and the alternating-current voltage increases.

As a result, a substance that adheres to the surface of the charging roller 16 and that has solidified on the surface in a film-like shape (due to the filming phenomenon) is broken (cut) in the thickness direction of the film, and the charging performance of the charging roller 16 is restored.

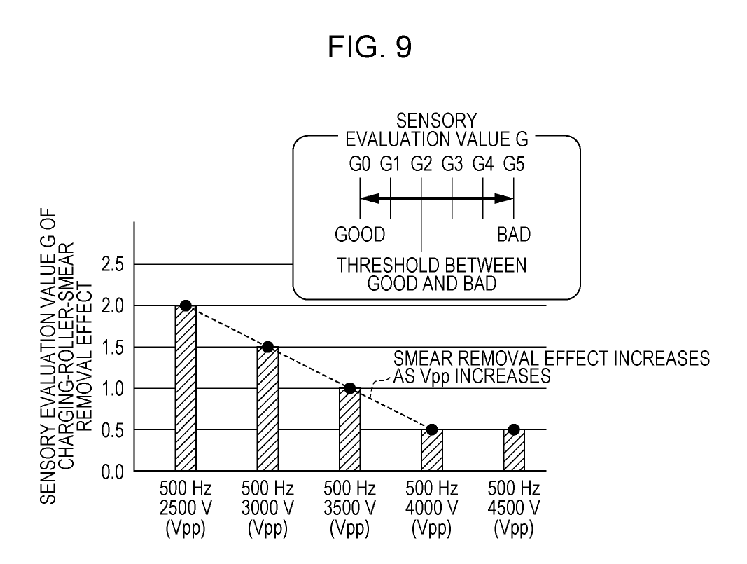

FIG. 9 is a characteristic diagram showing the sensory evaluation values of smear-removal effect for different voltages in a case where it is possible to increase the amplitude Vpp by reducing the frequency.

As illustrated in FIG. 9, the smear-removal effect increases as the amplitude Vpp increases, and the effect is maintained when the amplitude Vpp exceeds 4000 V.

In the present exemplary embodiment, after the processing amount has exceeded 100000 pages, the smear-removal processing is performed every time the processing amount increases by 10000 pages. However, an operator may manually input an instruction to perform the smear-removal processing. If the image forming apparatus 10 includes a device, such as an in-line sensor, that can detect a smear on the charging roller 16, whether or not to perform a smear-removal processing may be determined on the basis of a detection result obtained by the device.

The in-line sensor is a sensor for detecting, for example, the optical density of an image on a recording sheet P on which image-formation processing has been performed. By analyzing the detected optical density, if an image defect having a striped pattern extending in the transport direction (sub-scanning direction) of the recording sheet P is found, it is estimated that the charging roller 16 is smeared and the smear-removal processing is performed.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image forming unit that forms an image by forming an electrostatic latent image on an image carrier, which is charged by a charging member to which a normal voltage is applied, on the basis of image information and by supplying a developer to the image carrier;
an application unit that applies a special alternating-current voltage to the charging member, the special alternating-current voltage at least having an amplitude that is greater than that of an alternating-current voltage that is applied when forming the image; and
an instruction unit that instructs the application unit to apply the special alternating-current voltage at a specific time in a period other than an image forming period during which the image forming unit forms the image.

2. The image forming apparatus according to claim 1,
wherein the normal voltage is generated by superposing a normal alternating-current voltage on a direct-current voltage, and
wherein, by reducing a frequency of the normal alternating-current voltage, the amplitude of the special alternating-current voltage applied by the application unit is made greater than an amplitude of the normal alternating-current voltage superposed on the direct-current voltage.

3. The image forming apparatus according to claim 1,
wherein the instruction unit instructs the application unit to apply the special alternating-current voltage on condition that an amount of image-formation processing performed by the image forming unit exceeds a predetermined image-formation-processing amount.

4. The image forming apparatus according to claim 2,
wherein the instruction unit instructs the application unit to apply the special alternating-current voltage on condition that an amount of image-formation processing performed by the image forming unit exceeds a predetermined image-formation-processing amount.

5. The image forming apparatus according to claim 1,
wherein the amplitude of the special alternating-current voltage is set so that the special alternating-current voltage is capable of breaking a film generated due to solidification of a substance that adheres to the charging member as image-formation processing is continually performed.

6. The image forming apparatus according to claim 2,
wherein the amplitude of the special alternating-current voltage is set so that the special alternating-current voltage is capable of breaking a film generated due to solidification of a substance that adheres to the charging member as image-formation processing is continually performed.

7. The image forming apparatus according to claim 3,
wherein the amplitude of the special alternating-current voltage is set so that the special alternating-current voltage is capable of breaking a film generated due to solidification of a substance that adheres to the charging member as image-formation processing is continually performed.

8. The image forming apparatus according to claim 4,
wherein the amplitude of the special alternating-current voltage is set so that the special alternating-current voltage is capable of breaking a film generated due to solidification of a substance that adheres to the charging member as image-formation processing is continually performed.

9. The image forming apparatus according to claim 5,
wherein the instruction unit instructs the application unit to apply an alternating-current voltage in a period from a time at which an amount of image-formation processing performed by the image forming unit exceeds a predetermined image-formation-processing amount to a time at which the charging member is replaced, the predetermined image-formation-processing amount being determined on the basis of estimation of a deterioration time at which the substance adhering to the charging member starts to solidify.

10. The image forming apparatus according to claim 6,
wherein the instruction unit instructs the application unit to apply an alternating-current voltage in a period from a time at which an amount of image-formation processing performed by the image forming unit exceeds a predetermined image-formation-processing amount to a time at which the charging member is replaced, the predetermined image-formation-processing amount being determined on the basis of estimation of a deterioration time at which the substance adhering to the charging member starts to solidify.

11. The image forming apparatus according to claim 7,
wherein the instruction unit instructs the application unit to apply an alternating-current voltage in a period from a time at which an amount of image-formation processing performed by the image forming unit exceeds a predetermined image-formation-processing amount to a time at which the charging member is replaced, the predetermined image-formation-processing amount being determined on the basis of estimation of a deterioration time at which the substance adhering to the charging member starts to solidify.

12. The image forming apparatus according to claim 8,
wherein the instruction unit instructs the application unit to apply an alternating-current voltage in a period from a time at which an amount of image-formation processing performed by the image forming unit exceeds a predetermined image-formation-processing amount to a time at which the charging member is replaced, the predetermined image-formation-processing amount being determined on the basis of estimation of a deterioration time at which the substance adhering to the charging member starts to solidify.
